(19) United States
(12) Patent Application Publication
(10) Pub. No.: US 2015/0101151 A1
(43) Pub. Date: Apr. 16, 2015

(54) Lineman's Accessory Hook

(71) Applicant: Alan R. Greenleaf, Cleveland, OH (US)

(72) Inventor: Alan R. Greenleaf, Cleveland, OH (US)

(21) Appl. No.: 14/508,204

(22) Filed: Oct. 7, 2014

Related U.S. Application Data
(63) Continuation-in-part of application No. 29/469,518, filed on Oct. 10, 2013.
(60) Provisional application No. 61/889,495, filed on Oct. 10, 2013.

(51) Int. Cl. F16B 45/02; A62B 35/00

(52) U.S. Cl. CPC F16B 45/025; A62B 35/0037
USPC 24/132 R

(57) ABSTRACT

An accessory supporting hook holder is provide for supporting tools, equipment and the like from a lineman's took belt. The hook attaches in a locking fashion to a lineman's tool belt. A trigger release is specifically adapted so as to prevent accidental detachment when impacted by tree branches or other obstructions. A release trigger is at such an angle that any branch or other item that impacts it from below would tend to close the latch more, rather than urging it open.

### RELATED APPLICATIONS

The present application claims benefit of U.S. Provisional Application 61/889495, filed on Oct. 10, 2013 and incorporated by reference as if fully rewritten herein. The present application further incorporates subject matter also disclosed in copending U.S. patent application Ser. No. 29/469,518, also filed on Oct. 10, 2013 and incorporated by reference as if fully rewritten herein.

### BACKGROUND OF THE INVENTION

1. Field of the Invention

The present invention generally concerns belts, tool belts and portable, wearable tool holders and, more particularly, relates to any accessory supporting hook holder that attaches in a locking fashion to a lineman's tool belt.

2. Description of the Related Art

A lineman or linesman, also known as a powerline technician (PLT), is a tradesman who constructs and maintains electric power transmission and distribution facilities. The term is also used for those who install and maintain telephone, telegraph, cable TV and more recent fiber optic lines. For those in the trade who work in generally outdoor installation and maintenance jobs, these job functions often require work on or near electrically energized (live) and de-energized (dead) power lines. There are a variety of tasks often required, and a number of these tasks can expose these workers to electrical hazards, including installation or replacement of distribution equipment such as capacitor banks, distribution transformers on poles, insulators and fuses. The lineman's work often requires the use of ropes, knots, and lifting equipment, and many tasks may have to be performed with manual tools where accessibility is limited. Such conditions are common in rural or mountainous areas that are inaccessible to trucks.

Normally a crew of linemen will include several helpers to assist with on-the-ground tasks needed to support the linemen. Telephone and cable TV lines may sometimes be placed on the same utility poles as electric distribution circuits, so these workers and their helpers may be exposed to electrical hazards also (even though these lines are usually placed below the electric power lines in order to minimize contact with high-voltage electricity during maintenance).

All linemen and their helpers use personal protective equipment (PPE) as protection against inadvertent contact. This includes rubber gloves, rubber sleeves, bucket liners and protective blankets. Voltages higher than those that can be worked using gloves are worked with special sticks known as hot-line tools or hot sticks, with which power lines can be safely handled from a distance. Linemen must also wear special rubber insulating gear when working with live wires to protect against any accidental contact with the wire. The buckets linemen sometimes work from are also insulated with fiberglass.

Even de-energized power lines can be hazardous as they can still be energized from another source such as interconnection or interaction with another circuit even when it appears shut off. Consequently, all of the equipment used for these tasks must be kept clean from contaminants and regularly tested for dielectric integrity.

No two workmen are likely to use exactly the same set of transportable hand-held tools. Accordingly, tool belts having pouches and hooks and other tool holders have long accorded the potential to mount various tools. A search of the prior art did not disclose any patents that read directly on the claims of the instant invention; however, the following references were considered tangentially related.

U.S. Pat. No. 3,840,091, issued in the name of Conlon, describes a lineman's safety belt for securing around the waist of the user and includes a safety strap having latching hooks to pass around the pole and be latched to suitable loops on the body belt component, and a pole belt coupled to the safety strap. The safety strap and pole belt are coupled together at their midpoints, with the pole belt having buckle means at the ends for buckling the belt relatively closely around the pole. The pole belt includes barbs disposed to bite into the pole in the event of downward sliding movement of the pole belt. U.S. Pat. No. 4,712,646, issued in the name of Page, describes a lineman's safety strap assembly intended for attachment to a body belt. An elongated strap terminating in a buckle at one end for varying the length of the safety strip is provided with a first hook for coupling the safety strap to the body at the other end. A second hook for coupling the safety strap to the body belt is slidably mounted on the safety strap. An inclined sharp edged roller is slidably mounted on the safety strap for movement toward the midpoint of the strap. A cross belt terminating in spring-backed latches at both ends may be slidably coupled to the safety strap at two locations in order to form a closed loop for encircling the pole with the rollers facing inwardly. The assembly thus provides a braking feature in the event of a fall, but the configuration of the roller is such that it does not hinder the lineman in ascending or descending a wooden utility pole when the braking feature is not needed.

Further, U.S. Pat. No. 4,506,762, issued in the name of Bednar, discloses a tree and utility pole climbing process using climbing spurs and safety belts. The belt comprises a harness composed of a pair of cup shaped knee pads which are adjustably attached to the shin guard of the climbing spurs and 4 by means of adjustable straps and swivel harness snaps to ‘D’ rings on the safety belt surrounding the climber's waist. This minimizes the unnatural strain on the knee joints of the user.

While these references relate mostly to safety belts and not to work belts. While the present invention is not intended to be a safety device, these references show the ongoing need for these tradesmen to be in unique, difficult and dangerous locations to perform unanticipated tasks with only those tools and devices that they can carry with them. And, making certain that everything in contact with them is non-electrically conductive. Consequently, a need always exists for different and improved accessory supporting hook holders that attach in a locking fashion to a lineman's tool belt.

### SUMMARY OF THE INVENTION

It is therefore an object of the present invention to provide an improved lineman's hook accessory. It is a feature of the present invention to provide an improved accessory supporting hook holder that attaches in a locking fashion to a lineman's tool belt.

Briefly described according to the preferred embodiment of the present invention, a lineman's accessory hook is provided which clamps tightly onto a lineman's work belt in a locking fashion. A trigger release is provided that, when engaged, allows removal. The trigger release is specifically adapted so as to prevent accidental detachment when impacted by tree branches or other obstructions. The trigger is at such an angle that any branch or other item that impacts it from below would tend to close the latch more, rather than open it. The hook component that extends outward is particularly adapted for holding of coiled rope or similar equipment; however, additional configurations can be implemented, with the particular adaptation being a design choice for the intended use.

The lineman's accessory hook of the present invention can be unitarily molded as a single part. And, it may be formed of nonconductive material.

Further features and advantages of the invention will become apparent in the course of the following description.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a side front perspective view of a lineman's accessory hook according to the present invention;

FIG. 2 is a lower front perspective view thereof;

FIG. 3 is a front elevational view;

FIG. 4 is a rear elevational view thereof;

FIG. 5 is a left side elevational view, the opposite side being a mirror image thereof;

FIG. 6 is a top plan view thereof; and

FIG. 7 is a bottom plan view thereof.

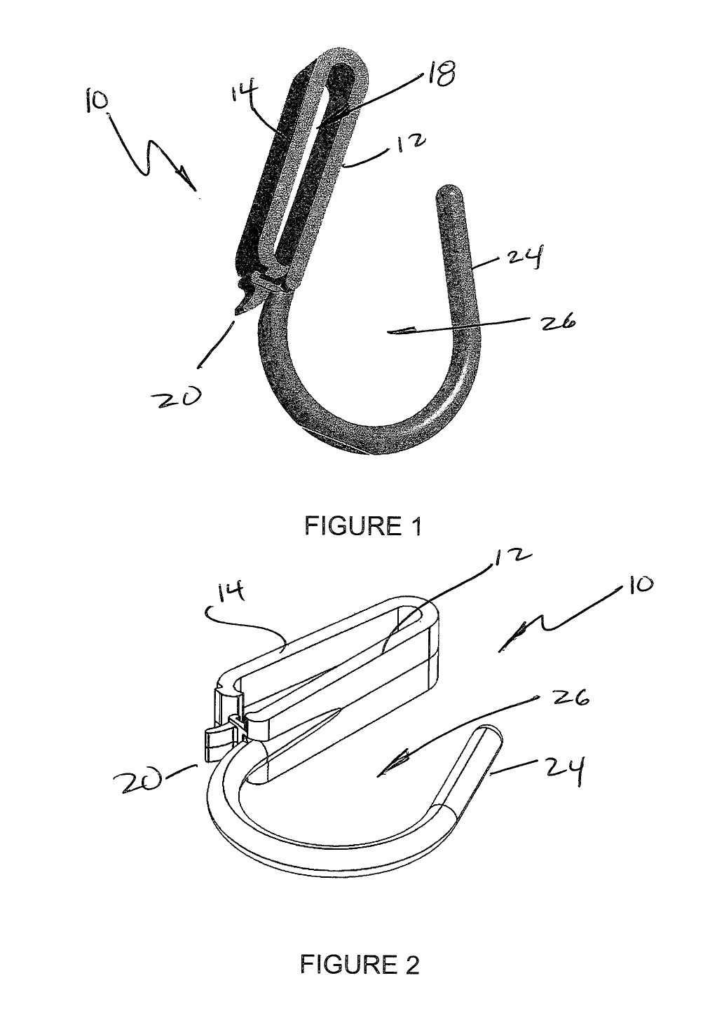

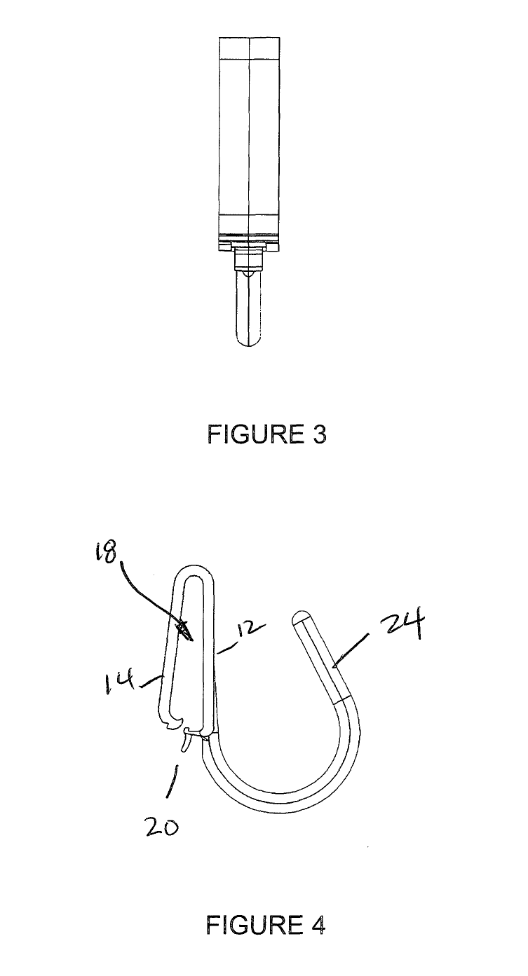

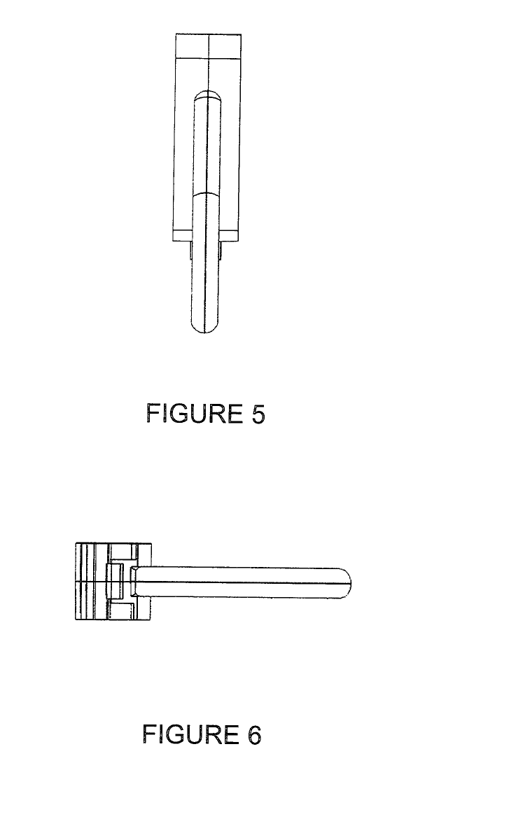

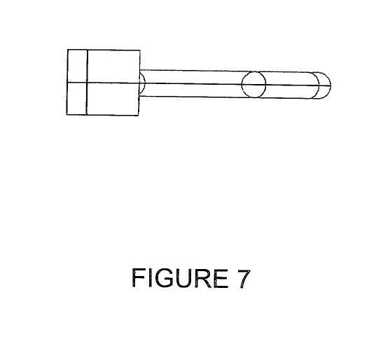

### DESCRIPTION OF THE PREFERRED EMBODIMENTS The best mode for carrying out the invention is presented in terms of its preferred embodiment, herein depicted within the Figures.

### 1. Detailed Description of the Figures

Before explaining the present invention in detail, it is important to understand that the invention is not limited in its application to the details of the construction illustrated and the steps described herein. The invention is capable of other embodiments and of being practiced or carried out in a variety of ways. It is to be understood that the phraseology and terminology employed herein is for the purpose of description and not of limitation. By way of example, and not as a limitation, reference to a “lineman” in the present invention is intended merely as an exemplary use, and other trades have similar or equivalent needs or uses. One other such example can include arborist, a professional in the practice of the cultivation, management, and study of individual trees, shrubs, vines, and other perennial woody plants, where the need for an accessory supporting hook holder that attaches in a locking fashion to a tool belt.

Referring now to the drawings, wherein like reference numerals indicate the same parts throughout the several views, a lineman's accessory hook, generally noted as 10, is shown according to the preferred embodiment of the present invention. The accessory hook 10 has an upper part formed of a front support plate 12 parallelly aligned with a rear support plate 14. The front support plate 12 and rear support plate 14 are narrowly spaced apart, forming a solid upper edge 16 in a generally “U” shape such as to encompass and be supported by a user's tool belt. The tool belt (not shown) in anticipated as being impinged within the first receiving space 18 formed between the support plates 12, 14.

The support plates 12, 14 clamp tightly onto a lineman's work belt in a locking fashion. A trigger release 20 is provided and formed at the lower end of the rear support plate 14. The trigger release 20 engages in a locking fashion with the lower edge of the front support plate 12.

The trigger release 20 is specifically adapted so as to prevent accidental detachment when impacted by tree branches or other obstructions. The trigger 22 is at such an angle that any branch or other item that impacts it from below would tend to close the latch more, rather than open it.

An attachment member 24 extends outward, both downwardly and cantilevered from the front support plate 12. The member 24 forms an upwardly arcuate shape, second receiving space 26. The second receiving space 26 may be particularly adapted for holding of coiled rope or similar equipment. It would be obvious to a person having ordinary skill in the relevant art, in light of the present teachings, to provide other configurations for the attachment member 24, with the particular adaptation being a design choice for the intended use.

### 2. Operation of the Preferred Embodiment

To use the present invention, a tradesman may slide the accessory hook 10 over his or her tool belt or safety harness belt such that the belt is contained snugly within the first receiving space 18 and the trigger release 20 locks. The user can then support a coil of rope (not shown) or other amenably adaptable tools that may be necessary onto the attachment member 24 prior to ascending to the necessary on site workspace. The trigger release 20 is specifically adapted so as to prevent accidental detachment when impacted by tree branches or other obstructions, but will release when manually engaged by the user.

The entire lineman's accessory hook 10 is intended to be molded as a unitary structure of a plastic, fiberglass, or otherwise non-conductive material.

The foregoing descriptions of specific embodiments of the present invention are presented for purposes of illustration and description. They are not intended to be exhaustive nor to limit the invention to precise forms disclosed and, obviously, many modifications and variations are possible in light of the above teaching. The embodiments are chosen and described in order to best explain principles of the invention and its practical application, to thereby enable others skilled in the art to best utilize the invention and its various embodiments with various modifications as are suited to the particular use contemplated. It is intended that a scope of the invention be defined broadly by the Drawings and

Specification appended hereto and to their equivalents. Therefore, the scope of the invention is in no way to be limited only by any adverse inference under the rulings of Warner-Jenkinson Company, v. Hilton Davis Chemical, 520 US 17 (1997) or Festo Corp. v. Shoketsu Kinzoku Kogyo Kabushiki Co., 535 U.S. 722 (2002), or other similar caselaw or subsequent precedent should not be made if any future claims are added or amended subsequent to this Patent Application.

What is claimed is:

1. A lineman's accessory hook comprising:
a unitary body molded as a single part and having a hook component that extends outward from a distal end;
a clamping member at a proximal end and adapted for providing a clamping force tightly onto a lineman's work belt in a locking fashion;
a trigger release that, when engaged, disengages said clamping member;

2. The lineman's accessory hook of claim 1, further comprising a trigger release shielding member specifically adapted so as to prevent accidental detachment.

3. The lineman's accessory hook of claim 2, wherein said trigger release shielding member is angularly disposed at said proximal end.

4. The lineman's accessory hook of claim 1, wherein said hook component is adapted for holding of coiled rope.

5. The lineman's accessory hook of claim 4, wherein said unitary body is formed of nonconductive material.

6. In an accessory supporting hook holder that attaches in a locking fashion to a lineman's tool belt, the improvement comprising a trigger release specifically adapted so as to prevent accidental detachment when impacted by tree branches or other obstructions and having a trigger at such an angle that any branch or other item that impacts it from below would tend to close the latch more, rather than open it.

7. The accessory supporting hook holder of claim 6 forming a supporting hook holder that attaches in a locking fashion to a lineman's tool belt and comprising:
a lineman's accessory hook which clamps tightly onto a lineman's work belt in a locking fashion;
a trigger release that, when engaged, allows removal of said hook form said work belt, said trigger release is specifically adapted so as to prevent accidental detachment when impacted by tree branches or other obstructions;
a hook component that extends outward.

8. The lineman's accessory hook of claim 7, wherein the entire assembly is unitarily molded of a dielectric material as a single part.

9. The lineman's accessory hook of claim 7, wherein said hook component further comprises:
an upper part formed of a front support plate parallelly aligned with a rear support plate;
said front support plate and said rear support plate being narrowly spaced apart and forming a solid upper edge in a generally “U” shape such as to encompass and be supported by a user's tool belt;

10. The lineman's accessory hook of claim 10, wherein a user's tool belt is impinged within a first receiving space formed between said front support plate and said rear support plate.

11. The lineman's accessory hook of claim 10, wherein said trigger release is provided and formed at a lower end of the rear support plate and said trigger release engages in a locking fashion with the lower edge of the front support plate.

12. The lineman's accessory hook of claim 11, wherein said trigger is at an angle relative to said front support plate.

13. The lineman's accessory hook of claim 12, further comprising an attachment member extending outward, both downwardly and cantilevered from the front support plate.

14. The lineman's accessory hook of claim 13, wherein said attachment member forms an upwardly arcuate shape, second receiving space.

15. A method of supporting and holding a coiled rope or similar equipment to a lineman's tool belt comprising:
a. obtaining a unitary body molded as a single part and having a hook component adapted for holding of coiled rope and that extends outward from a distal end; and
b. forming a trigger release specifically adapted so as to prevent accidental detachment when impacted by tree branches or other obstructions and having a trigger at such an angle that any branch or other item that impacts it from below would tend to close the latch more, rather than open it.

16. The method of claim 15, wherein said unitary body further comprises:
a clamping member at a proximal end and adapted for providing a clamping force tightly onto a lineman's work belt in a locking fashion;
a trigger release that, when engaged, disengages said clamping member; and
a trigger release shielding member specifically adapted so as to prevent accidental detachment.

17. The method of claim 16, wherein said trigger release shielding member is angularly disposed at said proximal end.

18. The method of claim 16, wherein said hook component is adapted for holding of coiled rope.

19. The method of claim 18, wherein said unitary body is formed of nonconductive material.
